(19) United States
(12) Patent Application Publication
(10) Pub. No.: US 2026/0358488 A1
(43) Pub. Date: Nov. 12, 2026

(54) METHOD FOR PROVIDING RANGE MONOPULSE RADAR SIGNAL USING EARLY-LATE PULSE COMPRESSION

(71) Applicant: RFCORE CO., LTD., Gyeonggi-do (KR)

(72) Inventor: Jin-Hee HAN, Gyeonggi-do (KR)

(21) Appl. No.: 19/266,484

(22) Filed: Jul. 11, 2025

(30) Foreign Application Priority Data
May 9, 2025 (KR) 10-2025-0060673

(51) Int. Cl. G01S 13/10; G01S 7/282; G01S 7/288; G01S 7/292; G01S 7/35; G01S 13/32

(52) U.S. Cl. CPC G01S 13/106; G01S 7/282; G01S 7/288; G01S 7/2921; G01S 7/354; G01S 13/32

(57) ABSTRACT

A method for providing a range monopulse radar signal using early-late pulse compression including transmitting the transmitted pulse code signal to provide a received pulse code signal as an early received pulse code signal, delaying the early received pulse code signal by half a reference time period to provide it as a puncture received pulse code signal, delaying the puncture received pulse code signal by half a reference time period to provide a late received pulse code signal, correlating the early received pulse code signal with the transmitted pulse code signal to provide a first correlation signal, correlating the late received pulse code signal with the transmitted pulse code signal to provide a second correlation signal, and subtracting the second correlation signal from the first correlation signal to synthesize a range monopulse radar signal.

### BACKGROUND

The present disclosure relates to a method for providing a range monopulse radar signal using early-late pulse compression, and more particularly, to a method for providing a range monopulse radar signal using early-late pulse compression, which can provide an early received pulse signal having the same signal as a received pulse signal to correlate it with a transmitted pulse signal, delay the early received pulse signal by one cycle to provide a late received pulse signal to correlate, and then subtract them from each other, thereby effectively improving a resolution of a range.

A monopulse radar measures a direction of a target object by comparing phases and amplitudes. To this end, four antennas are installed as receiving channels, and signals received from each channel are compared to calculate azimuth and elevation.

If a sum of signals from horizontal antennas is negative, a direction of azimuth is determined to be left, and if the sum of the signals from the horizontal antennas is positive, the direction of the azimuth is determined to be right.

Meanwhile, if a sum of signals from vertical antennas is negative, a direction of elevation is determined to be downward, and if the sum of the signals from the vertical antennas is positive, the direction of the elevation is determined to be upward.

However, a monopulse radar in the related art may precisely measure two-dimensional azimuth and elevation, but has a problem of not being able to precisely measure three-dimensional data, such as a range.

The background technology of the present disclosure is published in Korean Patent Registration No. 10-1544821 (published on August 10, 2015).

This invention was made with government support under [RS-2024-00400864] awarded by [Ministry of Science and ICT]. The government has certain rights in the invention.

### SUMMARY OF THE INVENTION

Accordingly, the present disclosure has been made to solve the problems of the prior art, and a technical problem to be achieved by the present disclosure is to provide a method for providing a range monopulse radar signal using early-late pulse compression, which can provide an early received pulse signal having the same signal as a received pulse signal to correlate it with a transmitted pulse signal, delay the early received pulse signal by one cycle to provide a late received pulse signal to correlate, and then subtract them from each other, thereby effectively improving a resolution of a range.

Technical problems to be solved in the present disclosure are not limited to the above-described problems and other technical problems which are not mentioned will definitely be understood by those skilled in the art from the following description.

In order to achieve the foregoing objectives, a method for providing a range monopulse radar signal using early-late pulse compression according to a first embodiment of the present disclosure, which is a method for providing a range monopulse radar signal using early-late pulse compression of a first correlation signal that correlates an early received pulse code signal with a transmitted pulse code signal, and a second correlation signal that correlates a late received pulse code signal with the transmitted pulse code signal, the method may include transmitting the transmitted pulse code signal to provide a received pulse code signal as an early received pulse code signal, delaying the early received pulse code signal by half a reference time period to provide it as a puncture received pulse code signal, delaying the puncture received pulse code signal by half of the reference time period to provide a late received pulse code signal, correlating the early received pulse code signal with the transmitted pulse code signal to provide a first correlation signal, correlating the late received pulse code signal with the transmitted pulse code signal to provide a second correlation signal, and subtracting the second correlation signal from the first correlation signal to synthesize a range monopulse radar signal.

Preferably, the method may further include performing coherent integration on a third correlation signal that correlates the puncture received pulse code signal with the transmitted pulse code signal, and detecting a phase of the integrated third correlation signal.

Preferably, the method may further include performing coherent integration on a signal that subtracts the second correlation signal from the first correlation signal, and canceling a phase of the integrated third correlation signal from a phase of the integrated subtracted signal.

Preferably, the method may further include, subsequent to the canceling step, checking a sign and magnitude of the integrated subtracted signal from which the phase is canceled out to detect whether the signal is a near sub-bin signal or a far sub-bin signal.

A method for providing a range monopulse radar signal using early-late pulse compression according to a second embodiment, which is a method for providing a range monopulse radar signal using early-late pulse compression of a second-first correlation signal that correlates a signal subtracting a late received pulse code signal from an early received pulse code signal, the method may include transmitting the transmitted pulse code signal to provide a received pulse code signal as an early received pulse code signal, delaying the early received pulse code signal by half a reference time period to provide it as a puncture received pulse code signal, delaying the puncture received pulse code signal by half a reference time period to provide a late received pulse code signal, and providing a second-first correlation signal that correlates a signal subtracting the late received pulse code signal from the early received pulse code signal.

Preferably, the method may further include performing coherent integration on a second-second correlation signal that correlates the puncture received pulse code signal with the transmitted pulse code signal, and detecting a phase of the integrated second-second correlation signal.

Preferably, the method may further include, subsequent to providing the second-first correlation signal, performing coherent integration on the second-first correlation signal, and canceling a phase of the integrated second-second correlation signal from a phase of the integrated second-first correlation signal.

Preferably, the method may further include, subsequent to the canceling step, checking a sign and magnitude of the second-first correlation signal from which the phase is canceled out to detect whether the signal is a near sub-bin signal or a far sub-bin signal.

A method for providing a range monopulse radar signal using early-late pulse compression according to a third embodiment, which is a method for providing a range monopulse radar signal using early-late pulse compression of a third-first correlation signal that correlates an early received linear frequency modulation signal with a transmitted linear frequency modulation signal, and a third-second correlation signal that correlates a late received linear frequency modulation signal with the transmitted linear frequency modulation signal, the method may include transmitting the transmitted linear frequency modulation signal to provide a received linear frequency modulation signal as an early received linear frequency modulation signal, delaying the early received linear frequency modulation signal by half a reference frequency to provide it as a puncture received linear frequency modulation signal, delaying the puncture received linear frequency modulation signal by half a reference frequency to provide it as a late received linear frequency modulation signal, correlating the early received linear frequency modulation signal with the transmitted linear frequency modulation signal to provide a third-first correlation signal, correlating the late received linear frequency modulation signal with the transmitted linear frequency modulation signal to provide a third-second correlation signal, and subtracting the third-second correlation signal from the third-first correlation signal to synthesize a range monopulse radar signal.

Preferably, the method may further include performing coherent integration on a third-third correlation signal that correlates the puncture received linear frequency modulation signal with the transmitted linear frequency modulation signal, and detecting a phase of the integrated third-third correlation signal.

Preferably, the method may further include performing coherent integration on a signal that subtracts the third-second correlation signal from the third-first correlation signal, and canceling a phase of the integrated third-third correlation signal from a phase of the integrated subtracted signal.

Preferably, the method may further include, subsequent to the canceling step, checking a sign and magnitude of the integrated subtracted signal from which the phase is canceled out to detect whether the signal is a near sub-bin signal or a far sub-bin signal.

A method for providing a range monopulse radar signal using early-late pulse compression according a fourth embodiment, which is a method for providing a range monopulse radar signal using early-late pulse compression of a fourth-first correlation signal that correlates a signal subtracting a late received linear frequency modulation signal from an early received linear frequency modulation signal, the method may include transmitting the transmitted linear frequency modulation signal to provide a received linear frequency modulation signal as an early received linear frequency modulation signal, delaying the early received linear frequency modulation signal by half a reference frequency to provide it as a puncture received linear frequency modulation signal, delaying the puncture received linear frequency modulation signal by half a reference frequency to provide it as a late received linear frequency modulation signal, and providing a fourth-first correlation signal that correlates a signal subtracting the late received linear frequency modulation signal from the early received linear frequency modulation signal.

Preferably, the method may further include performing coherent integration on a fourth-second correlation signal that correlates the puncture received linear frequency modulation signal with the transmitted linear frequency modulation signal, and detecting a phase of the integrated fourth-second correlation signal.

Preferably, the method may further include performing coherent integration on the fourth-first correlation signal, and canceling a phase of the integrated fourth-second correlation signal from a phase of the integrated fourth-first correlation signal.

Preferably, the method may further include, subsequent to the canceling step, checking a sign and magnitude of the fourth-first correlation signal from which the phase is canceled out to detect whether the signal is a near sub-bin signal or a far sub-bin signal.

A method for providing a range monopulse radar signal using early-late pulse compression according to embodiments of the present disclosure may provide an early received pulse signal having the same signal as a received pulse signal to correlate it with a transmitted pulse signal, delay the early received pulse signal by one cycle to provide a late received pulse signal to correlate, and then subtract them from each other, thereby simultaneously improving a range resolution and a radar range.

### BRIEF DESCRIPTION OF THE DRAWINGS

FIG. 1 is a block diagram showing a method for providing a range monopulse radar signal using early-late pulse compression according to a first embodiment of the present disclosure.

FIG. 2 is a block diagram of a radar system that performs a method for providing a range monopulse radar signal using early-late pulse compression according to a first embodiment of the present disclosure.

FIG. 3 is a block diagram of a radar system that performs a method for providing a range monopulse radar signal using early-late pulse compression according to a second embodiment of the present disclosure.

FIG. 4 is a block diagram showing a method for providing a range monopulse radar signal using early-late pulse compression according to a third embodiment of the present disclosure.

FIG. 5 is a block diagram of a radar system that performs a method for providing a range monopulse radar signal using early-late pulse compression according to a third embodiment of the present disclosure.

FIG. 6 is a block diagram of a radar system that performs a method for providing a range monopulse radar signal using early-late pulse compression according to a fourth embodiment of the present disclosure.

### DETAILED DESCRIPTION OF THE PREFERRED EMBODIMENT

The detailed description of the present disclosure described below refers to the accompanying drawings, which show, by way of illustration, specific embodiments to carry out the present disclosure. These embodiments are described in sufficient detail to enable those skilled in the art to carry out the present disclosure. It should be understood that various embodiments of the present disclosure are different from one another but are not necessarily mutually exclusive.

For example, it should be understood that specific shapes, structures, and characteristics described herein, in connection with one embodiment, may be implemented in other embodiments without departing from the principles of the present disclosure, and the positions or arrangements of individual elements within each disclosed embodiment may be modified without departing from the principles of the present disclosure.

Therefore, the following detailed description is not to be taken in a limiting sense, and the scope of the present disclosure is defined only by the appended claims along with the entire scope of equivalents thereof, if properly described.

In the drawings, similar reference symbols indicate identical or similar functions across various aspects, and lengths, areas, thicknesses, and shapes thereof may be exaggerated for convenience.

In addition, when a portion may "include" a certain element, unless specified otherwise, it may not be construed to exclude another element but may be construed to further include other elements.

A method for providing a range monopulse radar signal using early-late pulse compression according to first and second embodiments of the present disclosure provides a signal advanced by half a reference time period from a puncture received pulse code signal PPC1 as an early received pulse code signal EPC1, and provides a signal delayed by half a reference time period from the puncture received pulse code signal PPC1 as a late received pulse code signal LPC1.

Here, the reference time period may be set to be the same as a period of the puncture received pulse code signal PPC1, and may be set to various periods such as 1/2 period, 1/3 period, and 1/4 period of the puncture received pulse code signal PPC1.

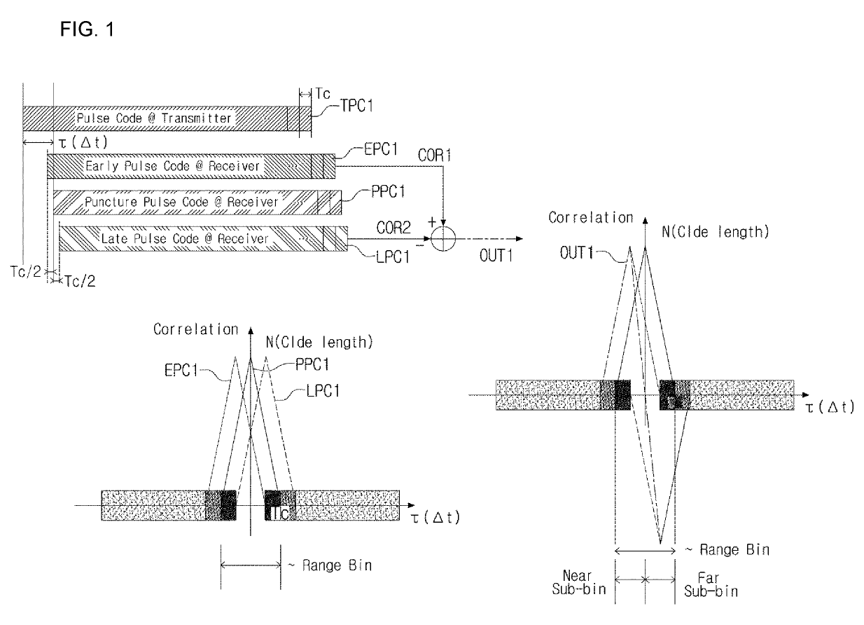

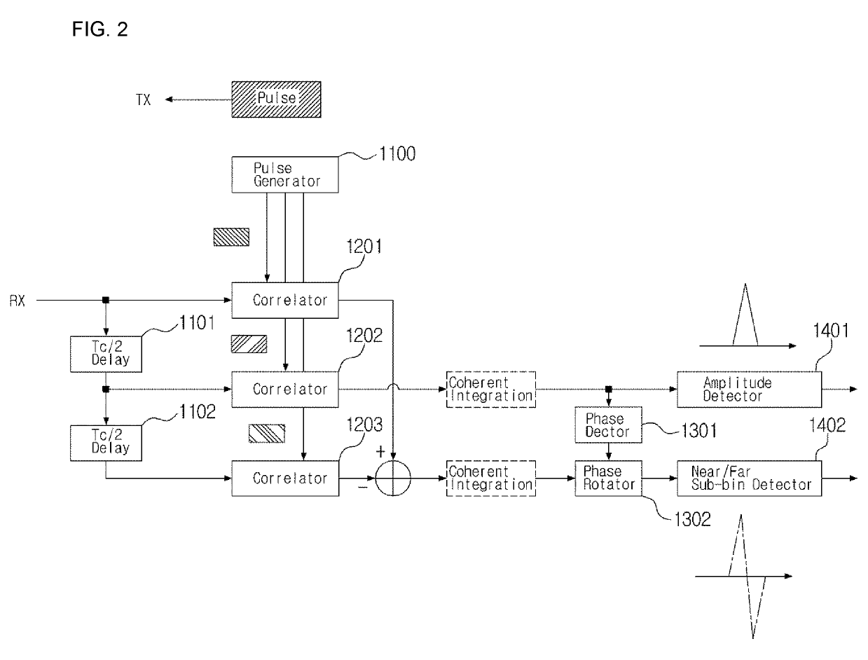

Meanwhile, a method for providing a range monopulse radar signal using early-late pulse compression according to a first embodiment of the present disclosure uses early-late pulse compression of a first correlation signal COR1 that correlates an early received pulse code signal EPC1 with a transmitted pulse code signal TPC1, and a second correlation signal COR2 that correlates a late received pulse code signal LPC1 with the transmitted pulse code signal TPC1, as shown in FIGS. 1 and 2.

Specifically, the transmitted pulse code signal TPC1 is transmitted to provide a received pulse code signal as an early received pulse code signal EPC1, a first delay 1101 delays the early received pulse code signal EPC1 by half a reference time to provide a puncture received pulse code signal PPC1, and a second delay 1102 delays the puncture received pulse code signal PPC1 by half a reference time to provide a late received pulse code signal LPC1.

In addition, a first correlator 1201 provides a first correlation signal COR1 by correlating the early received pulse code signal EPC1 with the transmitted pulse code signal TPC1, and a second correlator 1203 provides a second correlation signal COR2 by correlating the late received pulse code signal LPC1 with the transmitted pulse code signal TPC1, and the second correlation signal COR2 is subtracted from the first correlation signal COR1 to synthesize a range monopulse radar signal.

Meanwhile, a third correlator 1202 provides a third correlation signal that correlates the puncture received pulse code signal PPC1 with the transmitted pulse code signal TPC1, performs coherent integration on the third correlation signal, and a phase detector 1301 detects a phase of the integrated third correlation signal.

Then, coherent integration is performed on a signal that subtracts the second correlation signal COR2 from the first correlation signal COR1, and a phase rotator 1302 subtracts a phase of the integrated third correlation signal from a phase of the integrated subtracted signal to cancel it out.

Then, a sign and magnitude of the integrated subtracted signal from which the phase is canceled out is checked through a near-wave detector 1402 to detect whether the signal is a near sub-bin signal or a far sub-bin signal.

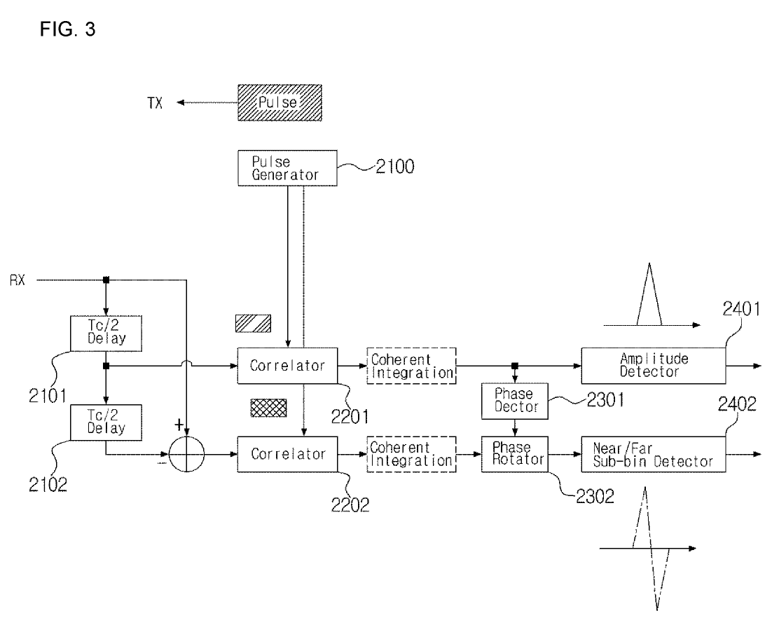

Meanwhile, a method for providing a range monopulse radar signal using early-late pulse compression according to a second embodiment of the present disclosure uses early-late pulse compression of a second-first correlation signal that correlates a signal subtracting a late received pulse code signal LPC1 from an early received pulse code signal EPC1, as shown in FIG. 3.

Specifically, the transmitted pulse code signal TPC1 is transmitted to provide a received pulse code signal as an early received pulse code signal EPC1, a second-first delay 2101 delays the early received pulse code signal EPC1 by half a reference time to provide a puncture received pulse code signal PPC1, and a second-second delay 2102 delays the puncture received pulse code signal PPC1 by half a reference time to provide a late received pulse code signal LPC1.

Additionally, a second-first correlator 2201 provides a second-first correlation signal that correlates a signal subtracting the late received pulse code signal LPC1 from the early received pulse code signal EPC1.

Meanwhile, a second-second correlator 2202 provides a second-second correlation signal that correlates the puncture received pulse code signal PPC1 with the transmitted pulse code signal TPC1, performs coherent integration on the second-second correlation signal, and a phase detector 2301 detects a phase of the integrated second-second correlation signal.

Then, coherent integration is performed on the second-first correlation signal, and a phase rotator 2302 subtracts a phase of the integrated second-second correlation signal from a phase of the integrated second-first correlation signal to cancel it out.

Then, a sign and magnitude of the second-first correlation signal from which the phase is canceled out is checked through a near-wave detector 2402 to detect whether the signal is a near sub-bin signal or a far sub-bin signal.

Meanwhile, a method for providing a range monopulse radar signal using early-late pulse compression according to third and fourth embodiments of the present disclosure provides a signal advanced by half a reference frequency from a puncture received linear frequency modulation signal PLFM1 as an early received linear frequency modulation signal ELFM1, and provides a signal delayed by half a reference frequency from the puncture received linear frequency modulation signal PLFM1 as a late received linear frequency modulation signal LLFM1.

Here, the reference frequency may be set to be the same as a frequency of the puncture received linear frequency modulation signal PLFM1, and may be set to various frequencies such as 1/2 frequency, 1/3 frequency, and 1/4 frequency of the puncture received linear frequency modulation signal PLFM1.

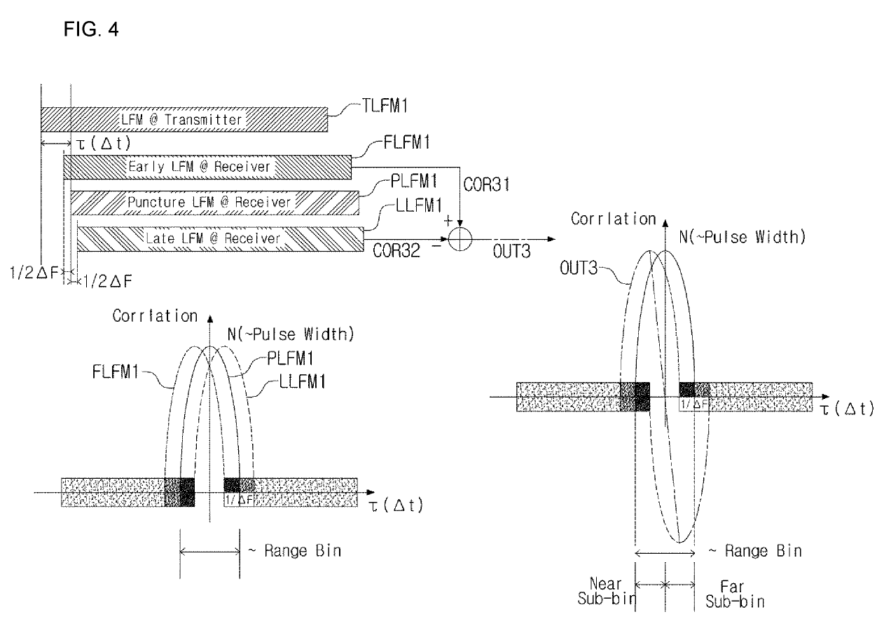

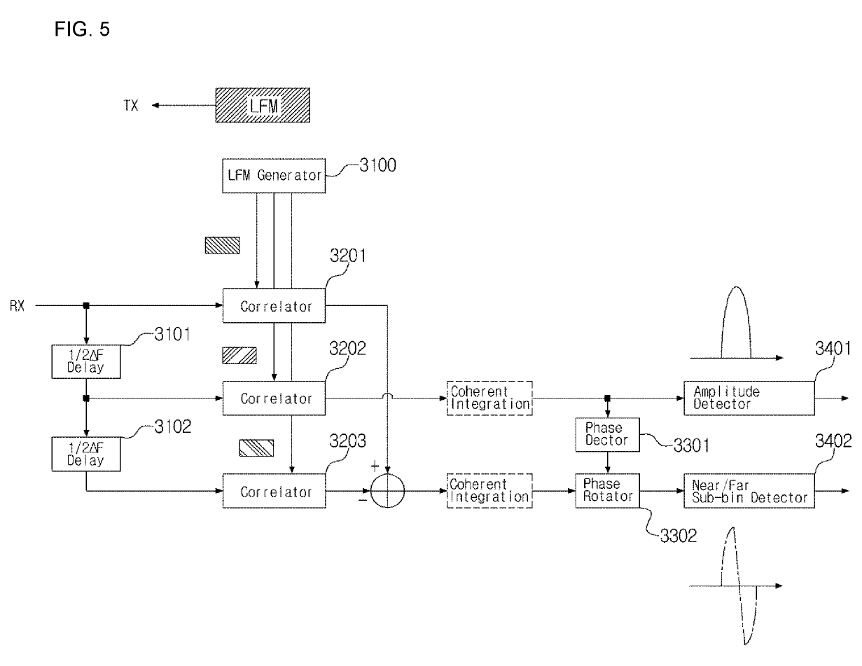

Meanwhile, a method for providing a range monopulse radar signal using early-late pulse compression according to a third embodiment of the present disclosure uses early-late pulse compression of a third-first correlation signal COR31 that correlates an early received linear frequency modulation signal ELFM1 with a transmitted linear frequency modulation signal TLFM1, and a third-second correlation signal COR32 that correlates a late received linear frequency modulation signal LLFM1 with the transmitted linear frequency modulation signal TLFM1, as shown in FIGS. 4 and 5.

Specifically, the transmitted linear frequency modulation signal TLFM1 is transmitted to provide a received linear frequency modulation signal as an early received linear frequency modulation signal ELFM1, a third-first delay 3101 delays the early received linear frequency modulation signal ELFM1 by half a reference frequency to provide a puncture received linear frequency modulation signal PLFM1, and a third-second delay 3102 delays the puncture received linear frequency modulation signal PLFM1 by half a reference frequency to provide a late received linear frequency modulation signal LLFM1.

In addition, a third-first correlator 3201 provides a third-first correlation signal COR31 that correlates the early received linear frequency modulation signal ELFM1 with the transmitted linear frequency modulation signal TLFM1, a third-second correlator 3203 provides a third-second correlation signal COR32 that correlates the late received linear frequency modulation signal LLFM1 with the transmitted linear frequency modulation signal TLFM1, and the third-second correlation signal COR32 is subtracted from the third-first correlation signal COR31 to synthesize a range monopulse radar signal.

Meanwhile, a third-third correlator 3202 provides a third-third correlation signal that correlates the puncture received linear frequency modulation signal PLFM1 with the transmitted linear frequency modulation signal TLFM1, performs coherent integration on the third-third correlation signal, and a phase detector 3301 detects a phase of the integrated third-third correlation signal.

Then, coherent integration is performed on a signal that subtracts the third-second correlation signal COR32 from the third-first correlation signal COR31, and a phase rotator 3302 subtracts a phase of the integrated third-third correlation signal from a phase of the integrated subtracted signal to cancel it out.

Then, a sign and magnitude of the integrated subtracted signal from which the phase is canceled out is checked through a near-wave detector 3402 to detect whether the signal is a near sub-bin signal or a far sub-bin signal.

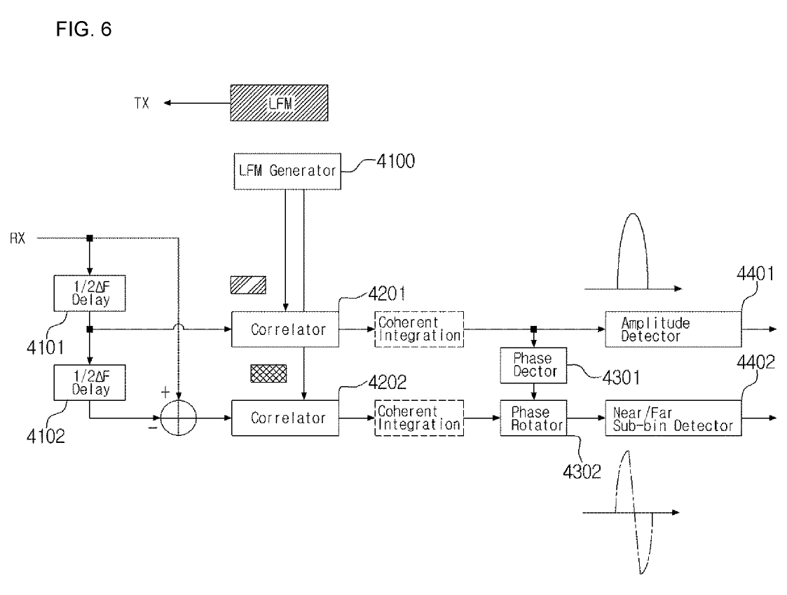

Meanwhile, a method for providing a range monopulse radar signal using early-late pulse compression according to a fourth embodiment of the present disclosure uses early-late pulse compression of a fourth-first correlation signal that correlates a signal subtracting a late received linear frequency modulation signal LLFM1 from an early received linear frequency modulation signal ELFM1, as shown in FIG. 6.

Specifically, the transmitted linear frequency modulation signal TLFM1 is transmitted to provide a received linear frequency modulation signal as an early received linear frequency modulation signal ELFM1, a fourth-first delay 4101 delays the early received linear frequency modulation signal ELFM1 by half a reference frequency to provide a puncture received linear frequency modulation signal PLFM1, and a fourth-second delay 4102 delays the puncture received linear frequency modulation signal PLFM1 by half a reference frequency to provide a late received linear frequency modulation signal LLFM1.

Additionally, a fourth-first correlator 4201 provides a fourth-first correlation signal that correlates a signal subtracting the late received linear frequency modulation signal LLFM1 from the early received linear frequency modulation signal ELFM1.

Meanwhile, a fourth-second correlator 4202 provides a fourth-second correlation signal that correlates the puncture received linear frequency modulation signal PLFM1 with the transmitted linear frequency modulation signal TLFM1, performs coherent integration on the fourth-second correlation signal, and a phase detector 4301 detects a phase of the integrated fourth-second correlation signal.

Then, coherent integration is performed on the fourth-first correlation signal, and a phase rotator 4302 subtracts a phase of the integrated fourth-second correlation signal from a phase of the integrated fourth-first correlation signal to cancel it out.

Then, a sign and magnitude of the fourth-first correlation signal from which the phase is canceled out is checked through a near-wave detector 4402 to detect whether the signal is a near sub-bin signal or a far sub-bin signal.

In the above, although the present disclosure has been described and shown with reference to preferred embodiments for illustrating the principles of the present disclosure, the present disclosure is not limited to the exact construction and operation shown and described.

Rather, those skilled in the art will readily appreciate that many changes and modifications to the present disclosure can be made without departing from the concept and scope of the appended claims.

Accordingly, all such appropriate changes, modifications, and equivalents should also be considered to fall within the scope of the present disclosure.

What is claimed is:

1. A method for providing a range monopulse radar signal using early-late pulse compression of a first correlation signal that correlates an early received pulse code signal with a transmitted pulse code signal, and a second correlation signal that correlates a late received pulse code signal with the transmitted pulse code signal, the method comprising:
transmitting the transmitted pulse code signal to provide a received pulse code signal as an early received pulse code signal;
delaying the early received pulse code signal by half a reference time period to provide it as a puncture received pulse code signal;
delaying the puncture received pulse code signal by half of the reference time period to provide a late received pulse code signal;
correlating the early received pulse code signal with the transmitted pulse code signal to provide a first correlation signal;
correlating the late received pulse code signal with the transmitted pulse code signal to provide a second correlation signal; and
subtracting the second correlation signal from the first correlation signal to synthesize a range monopulse radar signal.

2. The method of claim 1, further comprising:
performing coherent integration on a third correlation signal that correlates the puncture received pulse code signal with the transmitted pulse code signal; and
detecting a phase of the integrated third correlation signal.

3. The method of claim 2, further comprising:
performing coherent integration on a signal that subtracts the second correlation signal from the first correlation signal; and
canceling a phase of the integrated third correlation signal from a phase of the integrated subtracted signal.

4. The method of claim 3, further comprising:
subsequent to the canceling step,
checking a sign and magnitude of the integrated subtracted signal from which the phase is canceled out to detect whether the signal is a near sub-bin signal or a far sub-bin signal.

5. A method for providing a range monopulse radar signal using early-late pulse compression of a second-first correlation signal that correlates a signal subtracting a late received pulse code signal from an early received pulse code signal, the method comprising:
transmitting the transmitted pulse code signal to provide a received pulse code signal as an early received pulse code signal;
delaying the early received pulse code signal by half a reference time period to provide it as a puncture received pulse code signal;
delaying the puncture received pulse code signal by half a reference time period to provide a late received pulse code signal; and
providing a second-first correlation signal that correlates a signal subtracting the late received pulse code signal from the early received pulse code signal.

6. The method of claim 5, further comprising:
performing coherent integration on a second-second correlation signal that correlates the puncture received pulse code signal with the transmitted pulse code signal; and
detecting a phase of the integrated second-second correlation signal.

7. The method of claim 6, further comprising:
performing coherent integration on the second-first correlation signal; and
canceling a phase of the integrated second-second correlation signal from a phase of the integrated second-first correlation signal.

8. The method of claim 7, further comprising:
subsequent to the canceling step,
checking a sign and magnitude of the second-first correlation signal from which the phase is canceled out to detect whether the signal is a near sub-bin signal or a far sub-bin signal.

9. A method for providing a range monopulse radar signal using early-late pulse compression of a third-first correlation signal that correlates an early received linear frequency modulation signal with a transmitted linear frequency modulation signal, and a third-second correlation signal that correlates a late received linear frequency modulation signal with the transmitted linear frequency modulation signal, the method comprising:
transmitting the transmitted linear frequency modulation signal to provide a received linear frequency modulation signal as an early received linear frequency modulation signal;
delaying the early received linear frequency modulation signal by half a reference frequency to provide it as a puncture received linear frequency modulation signal;
delaying the puncture received linear frequency modulation signal by half a reference frequency to provide it as a late received linear frequency modulation signal;
correlating the early received linear frequency modulation signal with the transmitted linear frequency modulation signal to provide a third-first correlation signal;
correlating the late received linear frequency modulation signal with the transmitted linear frequency modulation signal to provide a third-second correlation signal; and
subtracting the third-second correlation signal from the third-first correlation signal to synthesize a range monopulse radar signal.

10. The method of claim 9, further comprising:
performing coherent integration on a third-third correlation signal that correlates the puncture received linear frequency modulation signal with the transmitted linear frequency modulation signal; and
detecting a phase of the integrated third-third correlation signal.

11. The method of claim 10, further comprising:
performing coherent integration on a signal that subtracts the third-second correlation signal from the third-first correlation signal; and
canceling a phase of the integrated third-third correlation signal from a phase of the integrated subtracted signal.

12. The method of claim 11, further comprising:
subsequent to the canceling step,
checking a sign and magnitude of the integrated subtracted signal from which the phase is canceled out to detect whether the signal is a near sub-bin signal or a far sub-bin signal.

13. A method for providing a range monopulse radar signal using early-late pulse compression of a fourth-first correlation signal that correlates a signal subtracting a late received linear frequency modulation signal from an early received linear frequency modulation signal, the method comprising:
transmitting the transmitted linear frequency modulation signal to provide a received linear frequency modulation signal as an early received linear frequency modulation signal;
delaying the early received linear frequency modulation signal by half a reference frequency to provide it as a puncture received linear frequency modulation signal;
delaying the puncture received linear frequency modulation signal by half a reference frequency to provide it as a late received linear frequency modulation signal; and
providing a fourth-first correlation signal that correlates a signal subtracting the late received linear frequency modulation signal from the early received linear frequency modulation signal.

14. The method of claim 13, further comprising:
performing coherent integration on a fourth-second correlation signal that correlates the puncture received linear frequency modulation signal with the transmitted linear frequency modulation signal; and
detecting a phase of the integrated fourth-second correlation signal.

15. The method of claim 14, further comprising:
performing coherent integration on the fourth-first correlation signal; and
canceling a phase of the integrated fourth-second correlation signal from a phase of the integrated fourth-first correlation signal.

16. The method of claim 15, further comprising:
subsequent to the canceling step,
checking a sign and magnitude of the fourth-first correlation signal from which the phase is canceled out to detect whether the signal is a near sub-bin signal or a far sub-bin signal.
